(19) United States
(12) Patent Application Publication
(10) Pub. No.: US 2015/0101905 A1
(43) Pub. Date: Apr. 16, 2015

(54) Flashcard Flip Chute

(71) Applicants: Duncan Milne, Auckland (NZ); Anna Kirschberg, Auckland (NZ)

(72) Inventors: Duncan Milne, Auckland (NZ); Anna Kirschberg, Auckland (NZ)

(73) Assignee: Duncan Milne, Huntington Beach, CA (US)

(21) Appl. No.: 14/053,099

(22) Filed: Oct. 14, 2013

(51) Int. Cl. G09B 3/00; B65G 11/08

(52) U.S. Cl. CPC G09B 3/00; B65G 11/081
USPC 193/27

(57) ABSTRACT

A learning device comprising of flashcard flip chute that rotates a flashcard horizontally and feeds the answer side out to the user. A receiver platform inside the flashcard flip chute is designed to collect the flashcard and rotate it horizontally based on an opening where the flashcard falls onto its side. The user can enter a flashcard which will feed along the platform, stop at the end or wall, and then rotate horizontally based on the opening being larger than the platform. The flashcard is then ejected from the flip chute, with the help of collection runners and the gradient of the bottom platform, enabling the user to see the answer side of the flashcard in a collection tray or on a table.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Flashcards are used as a popular method of teaching children basic mathematics and language skills. They typically work by printing a question on one side (such as 2+2) and an answer on the reverse (such as 4). Traditional flashcards have received some criticism as a self-learning method because small children may become bored as they have limited attention span. They may also become distracted and go off task, forget the answer, or peek at the answer.

Previous inventions have tried to overcome the problem of peeking through coding answers on the flashcard. U.S. Pat. No. 5,277,587 describes the use of a special holder with a numerical digital array that enables coded flashcards to provide the answer after being inserted into the holder. Another invention, U.S. Pat. No. 6,053,741, uses a receptacle for holding an information bearing card, with both a decoding display window and a moveable writing screen that enables the child to write down the answer before checking.

In an effort to overcome the monotony of flashcards, Dunn and Dunn (1993) presented a teaching method (referred to in their book: Teaching elementary students through their individual learning styles, Boston: Allyn & Bacon) where a flip chute is constructed by teachers as device that can flip the card over for the user. This flip chute can be constructed from a milk carton, where two slots (input and output slots) are cut, and two internal cardboard pieces are attached to connect the input slot with the output slot, creating a slide between the two that enables the flashcard to flip over after it is inserted, and then be ejected out of the bottom. The child can work with a packet of flashcards, entering the flashcard into the flip chute, saying the answer, and then self-checking with the correct answer that appears below (as the card is now flipped). However, a limitation of this device is that the card is flipped vertically (not horizontally), meaning the flashcard has to be printed with the answer upside-down on the reverse side for it to be in the correct orientation after being flipped. As the cards have to be flipped vertically, these flashcards can be counterintuitive to young children when they are used on their own. There are further complications for alphanumeric characters that may become spatially ambiguous when flipped the wrong way (such as 6 and 9; or d and p).

What is desired is a flip chute that is compatible with traditional flashcards (that are printed with question and answer on the same orientation) and enables the flashcards to be flipped horizontally.

### BRIEF SUMMARY

The present invention is a learning device for use with a set of flashcards where the question is presented on one side and an answer is presented on the other, each displayed in the same orientation. The learning device comprises of a tower with an input slot for placing flashcards and output opening for receiving flashcards.

According to an aspect of the invention, there is a plastic platform inside the input slot that receives the flashcard and facilitates a horizontal rotation of the flashcard, by an adjacent opening that enables the flashcard to drop to the right (or alternatively to the left in an opposite design), in comparison to the prior art where the flashcard would follow a slide to complete a vertical flip. In the current invention, the flashcard performs a horizontal flip by dropping to the right, being collected by runners, and finally moving down a plastic gradient to exit the flip chute in same orientation as it entered, but horizontally flipped.

### BRIEF DESCRIPTION OF THE DRAWINGS

These and other features and advantages of the various embodiments disclosed herein will be better understood with respect to the following description and drawings, in which:

FIG. 1 depicts a flashcard flip chute construction;

FIG. 2 depicts a flashcard flip chute side orientation.

### DETAILED DESCRIPTION

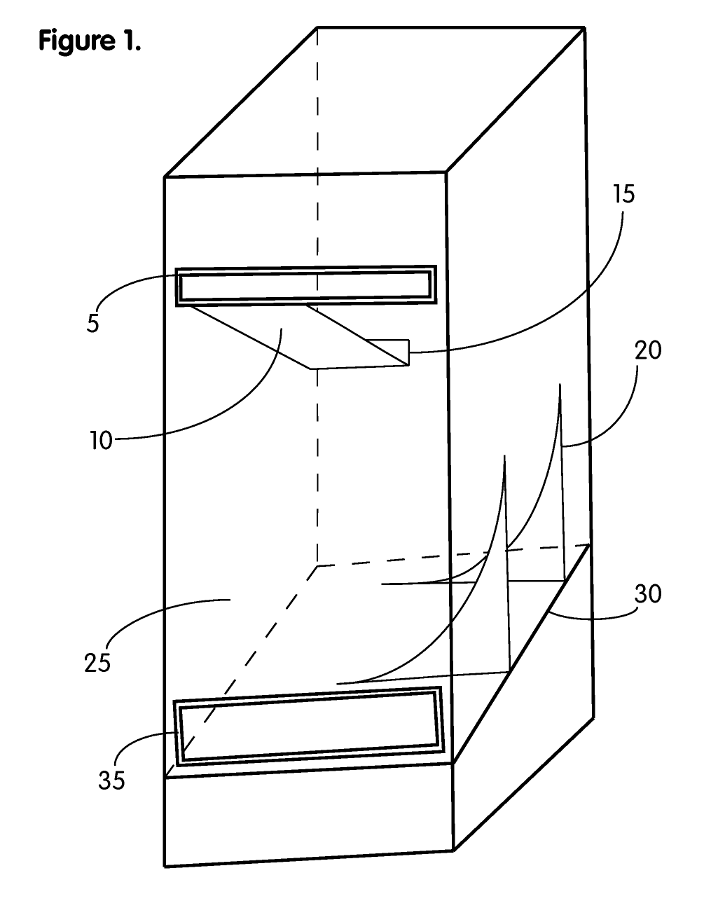

FIG. 1 shows an embodiment of a flashcard flip chute of the present invention. As shown in FIG. 1, the flashcard flip chute comprises of an input slot 5 where flashcards can be inserted. As the flashcard enters the flip chute it is supported by a receiving platform 10 which follows a gradual decent to support the ease of inserting a flashcard. The receiving platform also has a stop at the end 15. After the flashcard has be inserted into the input slot 5 and has travelled down the receiving platform to the stop 15, it will no longer be able to balance on the receiving platform 10 due to its size which is less than 50% the size of a flashcard and not large enough to balance a flashcard, forcing the flashcard to rotate over to the right. From here, the flashcard will be caught by a plastic runner or runners 20 that will catch and stabilize the flashcard on its opposite side. As the flashcard falls it will touch the left wall of the tower 25, and then be propelled forward due to the gradient of the platform at the bottom 30. Finally, the flashcard will exit out of the output opening 35, either onto the table or onto a collection tray 40.

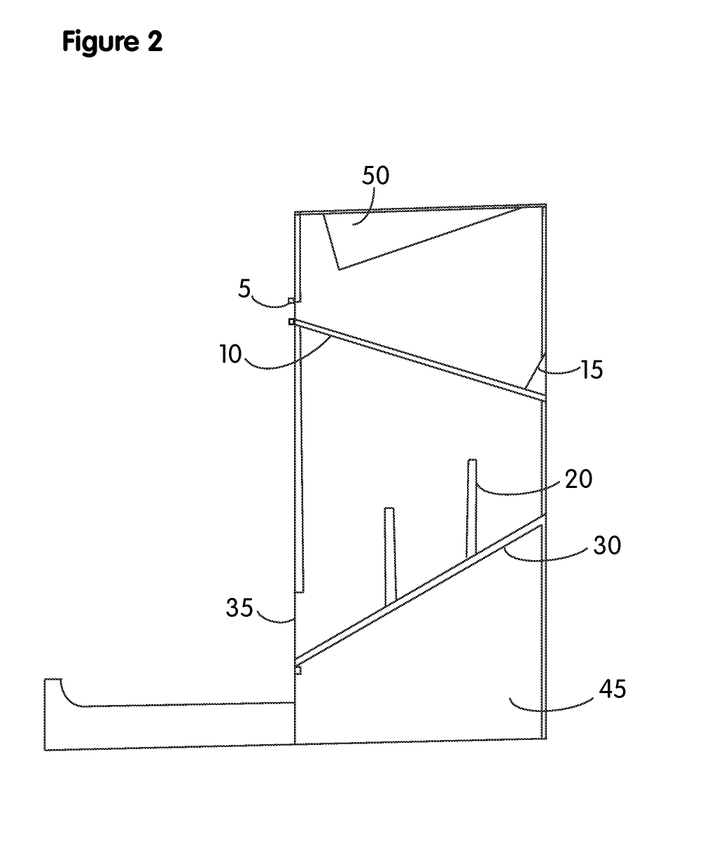

FIG. 2 represents a side orientation of the flashcard flip chute. It shows the input slot 5, receiver platform 10, stop 15, plastic runners 20, bottom platform 30, and output opening 35. It also shows the attachment of a collection tray 40 which can also be stored inside the flashcard flip chute 45. Finally, a shelf built into the top of the flashcard flip chute 50 can hold a set of flashcards, enabling the student to lift one card off from the top of the pile 50, insert it into the insert slot 5 and see the answer as it enters the collection tray 40.

What is claimed is:

1. A flip chute device where cards can be inserted and flipped horizontally by sliding off a platform that enables the card to rotate onto its left or right side.

2. A flip chute of claim 1 wherein a wall or stop prevents the flashcard moving forward.

3. A flip chute of claim 1 wherein a runner collects the rotated flashcard.

4. A flip chute of claim 1 wherein a gradient bottom platform propels the flashcard out of the flip chute.

5. A flip chute of claim 1 where a collection tray holds the flashcard as it propels out of the flip chute.

6. A flip chute of claim 1 where a collection tray can be stored in the base of the flip chute.

7. A flip chute of claim 1 where a storage tray holds flashcards on the top of the flip chute before use.
